(19) United States
(12) Patent Application Publication
(10) Pub. No.: US 2012/0170851 A1
(43) Pub. Date: Jul. 5, 2012

(54) MULTIMEDIA DEVICE AND MOTION COMPENSATION METHOD THEREOF

(75) Inventors: Hsiao-En CHANG, Hsinchu City (TW); Jian-De Jiang, Shaanxi (CN); I-Feng Lin, Hsinchu County (TW)

(73) Assignee: NOVATEK MICROELECTRONICS CORP., Hsinchu (TW)

(21) Appl. No.: 13/241,489

(22) Filed: Sep. 23, 2011

(30) Foreign Application Priority Data
Jan. 3, 2011 (TW) 100100095

(51) Int. Cl. G06K 9/48

(52) U.S. Cl. 382/197

(57) ABSTRACT

A multimedia device and a motion compensation method thereof are provided for generating a middle frame between two frames. The multimedia device includes an interpolation unit, a linear process unit and a combination unit. The interpolation unit generates a first reference pixel data according to the relationship among a first pixel data, a second pixel data, and a third pixel data. The first and the second pixel data are obtained according to the location of a to-be-generated pixel and a relative motion vector. The third pixel data is obtained according to the two pixels data. The linear process unit provides a linear combination of the first and the second pixel data to generate a second reference pixel data. The combination unit combines the two reference pixel data according to the difference between the first and the second pixel data to generate a pixel data for the to-be-generated pixel.

This application claims the benefit of Taiwan application Serial No. 100100095, filed Jan. 3, 2011, the subject matter of which is incorporated herein by reference.

### BACKGROUND

1. Technical Field

The disclosure relates in general to an electronic device and a control method thereof, and more particularly to a multimedia device and a motion compensation method thereof.

2. Description of the Related Art

In response to the requirement of liquid crystal TV, more and more researches are focused in the field of motion estimation/motion compensation (ME/MC). Motion compensation is an algorithmic technique employed in the encoding of video data for video compression

In general, motion estimation refers to a method for determining motion vectors from adjacent frames. The motion vectors describe the transformation from one frame to another. The motion vector can relate to the whole frame (global motion estimation) or specific parts thereof, such as rectangular blocks, arbitrary shaped patches or even per pixel. Furthermore, applying the motion vectors to a frame to synthesize the transformation to another frame is called motion compensation. The combination of motion estimation and motion compensation is a commonly used technology in image compression.

According to motion estimation/motion compensation, two frames to be displayed on the screen are analyzed, and a middle state of the two frames is estimated through calculation. That is, an interpolation frame is generated between the two frames. Referring to FIG. 1, a schematic diagram of an example of generating a middle frame by way of motion estimation/motion compensation is shown. Firstly, moving objects such as an object Obj on the two frames I-frame and P-frame are located by using motion estimation algorithm. Next, a motion vector MV, which denotes the movement path of the object Obj on the frame, is calculated according to the difference between the two frames I-frame and P-frame. Then, motion compensation algorithm is used for estimating the middle state of the moving object Obj according to the motion vector MV and the two frames I-frame and P-frame, thus generating an interpolation frame M-frame.

However, if the motion vector generated by the motion estimation algorithm is incorrect, then the interpolation frame generated by the motion compensation algorithm would be erroneous. When such erroneous interpolation frame is inserted into a sequence of frames and displayed, the viewer would feel uncomfortable. For example, when a small object moves in the background, the object cannot be effectively separated from the background, and the motion estimation algorithm which cannot locate the correct motion vector of the small object will replace the motion vector of the small object with the motion vector of the background instead. As such, when the motion compensation algorithm is performed, the object will appear in the background of the interpolation frame. Thus, as regards motion estimation/motion compensation, how to increase the correctness in determining the pixel data of the interpolation frame has become an imminent task for the industries.

### SUMMARY OF THE DISCLOSURE

The disclosure is directed to a multimedia device and a motion compensation method thereof for eliminating the appearance of the object in the frame background so as to increase the correctness in determining the pixel data of the interpolation frame and the smoothness of the displayed frames.

According to an embodiment, a multimedia device is provided for generating a middle frame between a first frame and a second frame. The multimedia device includes an interpolation unit, a linear process unit, and a combination unit. The interpolation unit generates a first reference pixel data according to the ordering relationship among a first pixel data of the first frame, a second pixel data of the second frame, and a third pixel data. The first pixel data and the second pixel data are obtained according to the location of a to-be-generated pixel of the middle frame and a relevant motion vector. The third pixel data is obtained according to two pixels data, which have substantially the same location in the first and the second frames as that of the to-be-generated pixel in the middle frame. The linear process unit linearly combines the first pixel data and the second pixel data to generate a second reference pixel data. The combination unit combines the first reference pixel data and the second reference pixel data according to the difference between the first pixel data and the second pixel data to generate a pixel data for the to-be-generated pixel.

According to an alternative embodiment, the motion compensation method of a multimedia device is used for generating a middle frame a first frame and a second frame received by the multimedia device. The motion compensation method includes the following steps. A first reference pixel data is generated according to the ordering relationship among a first pixel data of the first frame, a second pixel data of the second frame, and a third pixel data. The first pixel data and the second pixel data are obtained according to the location of a to-be-generated pixel of the middle frame and a relevant motion vector, and the third pixel data is obtained according to two pixels data, which have substantially the same location in the first and the second frames as that of the to-be-generated pixel in the middle frame. A linear combination of the first pixel data and the second pixel data is provided to generate a second reference pixel data. The first reference pixel data and the second reference pixel data are combined according to the difference between the first pixel data and the second pixel data to generate a pixel data for the to-be-generated pixel.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of an example of generating a middle frame by way of motion estimation/motion compensation;

FIG. 2A shows a block diagram of an example of a multimedia device according to an embodiment of the disclosure;

FIG. 2B shows a schematic diagram of an example of generating a middle frame between a first frame and a second frame by a multimedia device according to an embodiment of the disclosure; and

FIG. 3 shows a circuit diagram of an example of the multimedia device of FIG. 2A.

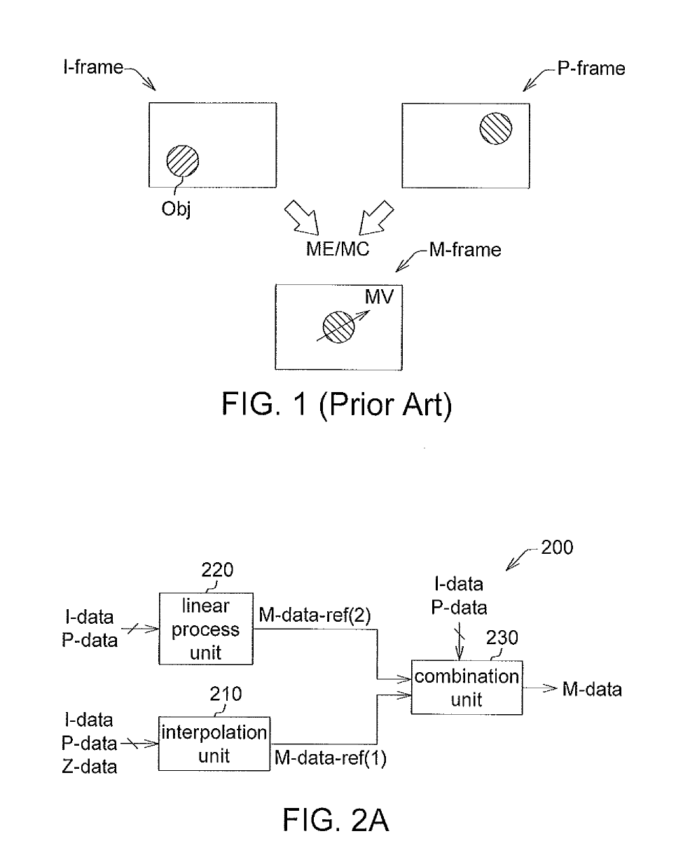

### DETAILED DESCRIPTION OF THE DISCLOSURE

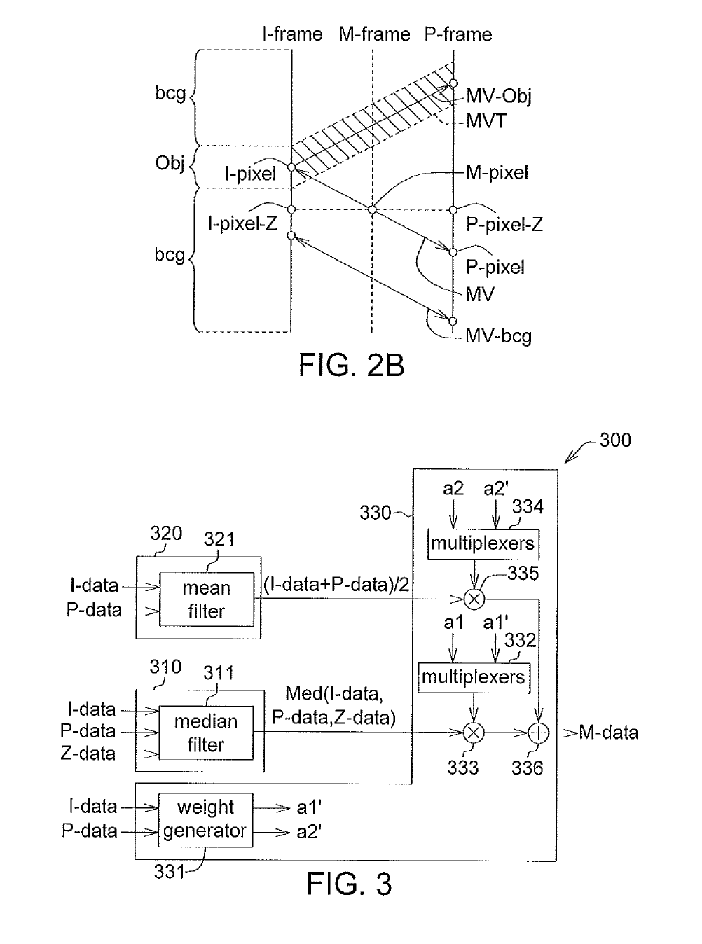

Refer to FIG. 2A and FIG. 2B. FIG. 2A shows a block diagram of an example of a multimedia device according to an embodiment of the disclosure. FIG. 2B shows a schematic diagram of an example of generating a middle frame between a first frame and a second frame by a multimedia device according to an embodiment of the disclosure. In the example of FIG. 2B, an object Obj moves in the background bcg of the frame. For example, the object Obj moves to a second frame P-frame from a first frame I-frame along a movement path MT. The multimedia device 200 generates a middle frame M-frame between the first frame I-frame and the second frame P-frame. As indicated in FIG. 2A, the multimedia device 200 includes an interpolation unit 210, a linear process unit 220, and a combination unit 230. The operation relationships among the units are disclosed below.

The interpolation unit 210 generates a first reference pixel data M-data-ref(1) according to the ordering relationship among a first pixel data I-data of the first frame I-frame, a second pixel data P-data of the second frame P-frame, and a third pixel data Z-data. The two pixels data I-data and P-data, such as the pixel data of the pixels I-pixel and P-pixel, can be obtained according to the location of a to-be-generated pixel M-pixel in the middle frame M-frame and a relevant motion vector MV. The motion vector MV is for example previously provided by using an algorithm of motion estimation at a previous stage. The third pixel data Z-data can be obtained according to two pixel data which have substantially the same location in the first frame I-frame and the second frame P-frame as that of the to-be-generated pixel M-pixel in the middle frame M-frame, such as two pixel data of the pixels I-pixel-Z and P-pixel-Z. The linear process unit 220 linearly combines the first pixel data I-data and the second pixel data P-data to generate a second reference pixel data M-data-ref(2). The combination unit 230 combines the first reference pixel data M-data-ref(1) and the second reference pixel data M-data-ref(2) according to the difference between the first pixel data I-data and the second pixel data P-data to generate a pixel data M-data for the to-be-generated pixel M-pixel.

According to the multimedia device disclosed in the above embodiment of the disclosure, two reference pixel data are combined according to the difference between the pixel data of two frames, and proportions of the two reference pixel data obtained in different ways can be adjusted, so that the appearance of the object in the background of the frame can be eliminated. As such, the correctness in determining the middle frame can be increased, and the smoothness of the displayed frames can be increased. Exemplary embodiments of the multimedia device are provided in the following for further illustration.

Refer to FIG. 2B and FIG. 3. FIG. 3 shows a circuit diagram of an example of the multimedia device of FIG. 2A. The multimedia device 300, which includes an interpolation unit 310, a linear process unit 320, and a combination unit 330, generates a middle frame M-frame between a first frame I-frame and a second frame P-frame.

The interpolation unit 310 comprises a median filter 311. The median filter 311 generates a first reference pixel data M-data-ref(1) according to a median among the first pixel data I-data of the pixel I-pixel of the first frame I-frame, the second pixel data P-data of the pixel P-pixel of the second frame P-frame, and the third pixel data Z-data. For example, the median is obtained from a function of Med(I-data, P-data, Z-data). As regards conventional methods, the pixel data of the two pixels I-pixel and P-pixel are directly mixed with each other so that the object appears in the background of the middle frame M-frame. In the present embodiment, a first reference pixel data M-data-ref(1) is generated by using a median, which eliminates the appearance of the object in the background and increases the correctness in determining the pixel data of the middle frame M-frame.

For example, in view of the to-be-generated pixel M-pixel of the middle frame M-frame, the two pixels I-pixel and P-pixel can be determined by the multimedia device 300 using the location of the to-be-generated pixel M-pixel and a relevant motion vector MV. The motion vector MV relevant to the to-be-interpolated pixel M-pixel can be provided by using the location of the to-be-interpolated pixel M-pixel in a motion estimation algorithm. From the location of the to-be-generated pixel M-pixel, the motion vector MV can be projected on the frames I-frame and P-frame, so as to identify the location of the two pixels I-pixel and P-pixel, and obtain their pixel data I-data and P-data. Since the area of the moving object Obj in the background may be too small for the motion estimation algorithm to effectively distinguish the object from the background, most of the motion vectors generated by the motion estimation algorithm are in the same direction as background motion vectors. In other words, for the to-be-generated pixel M-pixel of FIG. 2B, although the location of the to-be-generated pixel M-pixel is close to the object Obj, the motion vector MV provided by the motion estimation algorithm usually is in the same direction as the background motion vector MV-bcg, not in the same direction as the object motion vector MV-Obj denoting the movement path MP of the object Obj.

However, in a case where the to-be-generated pixel M-pixel in the background is exemplified as a pixel not in the movement path MT of the object, the projection of the motion vector MV may identify a pixel which is located in the movement path MP of the object Obj, such as the first pixel I-pixel. In this case, if the pixel data I-data and P-data of the two pixels I-pixel and P-pixel are directly combined with each other, an erroneous pixel data will be generated and assigned to the to-be-generated pixel M-pixel. As a result, the object Obj will appear in the background of the middle frame M-frame, such as in the to-be-generated pixel M-pixel which is not located in the movement path MT.

In the present embodiment, as indicated in FIG. 3, the interpolation unit 310 further determines the pixel data of the to-be-generated pixel M-pixel according to the third pixel data Z-data, so as to eliminate the appearance of the object in the background. The third pixel data Z-data can be obtained by the multimedia device 300. For example, the multimedia device 300 bases on two pixel data which have substantially the same location in the first frame I-frame and the second frame P-frame as that of the to-be-generated pixel M-pixel in the middle frame M-frame, such as pixel data of the two pixels I-pizel-Z and P-pixel-Z of FIG. 2B, or two pixel data of another pixels adjacent to them. Since the two pixels I-pizel-Z and P-pixel-Z are not located in the movement path MP of the object, the generated third pixel data Z-data can help the interpolation unit 310 to increase the correctness in determining the pixel data of the to-be-generated pixel M-pixel.

In an embodiment, the third pixel data Z-data is generated by the multimedia device 300 according to a mean between the pixel data of the two pixels I-pizel-Z and P-pixel-Z. In FIG. 2B, it is assumed that the first pixel I-pixel is an object in white color, the second pixel P-pixel is a background in green color, and the two pixels I-pizel-Z and P-pixel-Z are also in green color. As such, an averaged third pixel data Z-data also denotes green color. On the other hand, if pixel data of the first and the second pixels I-pixel and P-pixel are directly combined with each other, the combined color will be light green, meaning that the white object appears in the green background. In the present embodiment of the disclosure, the median filter 311 of the interpolation unit 310 will generate a first reference pixel data M-data-ref(1) denoting green color according to the median among three pixel data of white color, the green color, and the green color. Here, the generated data of green color is similar to the background color. Thus, the present embodiment makes it more robust to prevent the object from appearing in the background and increase the correctness of the pixel data.

The linear process unit 320 generates a second reference pixel data M-data-ref(2) by linearly combining the first pixel data I-data and the second pixel data P-data. The applicant finds that in such a frame shot for example by a technique of panning where the motion vectors of the frame are highly consistent with each other, e.g., most of them direct to substantially the same or similar direction(s), the backgrounds of the frame will have uniform or homogenous movement. Thus, the second reference pixel data M-data-ref(2) generated by linear combination according to the present embodiment of the disclosure effectively increases the correctness in determining the pixel data of such frame and increases the smoothness in the displayed frames.

In the present embodiment of the disclosure, the linear process unit 320 comprises a mean filter 321. The mean filter 321 generates a second reference pixel data M-data-ref(2) according to the mean of the first pixel data I-data and the second pixel data P-data, such as according to a function of (I-data+P-data)/2. However, the use of mean to generate a second reference pixel data M-data-ref(2) is made as an example embodiment of the disclosure, and the disclosure is not limited thereto.

The combination unit 330 combines the first reference pixel data M-data-ref(1) and the second reference pixel data M-data-ref(2) according to the difference between the first pixel data I-data and the second pixel data P-data to generate the pixel data M-data of a to-be-generated pixel M-pixel. For example, when the difference between the two pixels data I-data and P-data is large, this implies that the appearance of the object will occur if the two pixel data are directly combined with each other. Under such circumstances, the present embodiment of the disclosure can increase the proportion of the first reference pixel data M-data-ref(1) generated by the interpolation unit 310 so as to eliminate the appearance of the object and increase the correctness of the frame data. Moreover, when the difference between the two pixels data I-data and P-data is small, this implies that the motion vectors of the frame are highly consistent with each other. Under such circumstances, the present embodiment of the disclosure can increase the proportion of the second reference pixel data M-data-ref(2) generated by the linear process unit 320 so as to increase the smoothness in displayed frames. Thus, by adjusting the proportions of the reference pixel data obtained in different ways, the present embodiment of the disclosure can eliminate the appearance of the object in the background so as to increase the correctness in determining the frame data and the smoothness in displayed frames.

In an embodiment, when combining two pixels data I-data and P-data, the combination unit 330 can linearly combines the first reference pixel data M-data-ref(1) and the second reference pixel data M-data-ref(2) to generate the pixel data of the to-be-generated pixel M-pixel.

An example is made as follows with reference to FIG. 3. In this example, the combination unit 330 includes a weight generator 331, two multiplexers 332 and 334, two multipliers 333 and 335, and an adder 336. The multiplexers 332 and 334 select and deliver two predetermined parameters a1 and a2 of the multimedia device 300 to the multipliers 333 and 335 respectively. The sum of the parameters a1 and a2 is, for example but non-limitedly, equal to 1. The first multiplier 333 calculates the product of the first reference pixel data M-data-ref(1) multiplied by the parameter a1, the second multiplier 335 calculates the product of the second reference pixel data M-data-ref(2) multiplied by the parameter a2, and the adder 336 further generates the pixel data M-data of the to-be-generated pixel M-pixel according to the sum of the two products.

The weight generator 331 determines a first parameter a1′ and a second parameter a2′ according to the difference between the first pixel data I-data and the second pixel data P-data. The sum of the two parameters a1′ and a2′ is, for example but non-limitedly, equal to 1. The weight generator 331 further determines whether the difference between the first pixel data I-data and the second pixel data P-data is larger than a threshold. If the difference is not larger than the threshold, then the multiplexers 332 and 334 output the predetermined parameters a1 and a2. If the difference is larger than the threshold, then the multiplexers 332 and 334 output the first and the second parameters a1′ and a2′. Furthermore, if the difference is larger than a larger threshold, the weight generator 331 of the combination unit 330 increases the first parameter a1′ and decreases the second parameter a2′. As such, when the difference between the two pixels data I-data and P-data increases, the present embodiment of the disclosure can increase the proportion of the first reference pixel data M-data-ref(1) so as to eliminate the appearance of the object in the frame background and increase the correctness of the frame data. Moreover, when the difference thereof decreases, the present embodiment of the disclosure further increases the proportion of the second reference pixel data M-data-ref(2) to increase the smoothness in displayed frames.

According to the multimedia device and the motion compensation method thereof disclosed in the above exemplary embodiments, two reference pixel data are combined according to a difference between pixel data of two frames. Thus, proportions of the reference pixel data obtained in different ways can be adjusted, so that the appearance of the object in the background of the frame can be eliminated, the correctness of the frame data increased, and the smoothness in displayed frames increased.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multimedia device for generating a middle frame between a first frame and a second frame, wherein the multimedia device comprises:
an interpolation unit for generating a first reference pixel data according to the ordering relationship among a first pixel data of the first frame, a second pixel data of the second frame, and a third pixel data, wherein the first pixel data and the second pixel data are obtained according to the location of a to-be-generated pixel of the middle frame and a relevant motion vector, and the third pixel data is obtained according to two pixels data which have substantially the same location in the first and the second frames as that of the to-be-generated pixel in the middle frame;
a linear process unit for linearly combining the first pixel data and the second pixel data to generate a second reference pixel data; and
a combination unit for combining the first reference pixel data and the second reference pixel data according to a difference between the first pixel data and the second pixel data to generate a pixel data for the to-be-generated pixel.

2. The multimedia device according to claim 1, wherein the interpolation unit comprises a median filter for generating the first reference pixel data according to a median among the first pixel data, the second pixel data, and the third pixel data.

3. The multimedia device according to claim 1, wherein the linear process unit comprises a mean filter for generating the second reference pixel data according to a mean between the first pixel data and the second pixel data.

4. The multimedia device according to claim 1, wherein the combination unit linearly combines the first reference pixel data and the second reference pixel data according to the difference between the first pixel data and the second pixel data to generate the pixel data for the to-be-generated pixel.

5. The multimedia device according to claim 4, wherein the combination unit comprises:
a weight generator for determining a first parameter and a second parameter according to the difference between the first pixel data and the second pixel data;
a first multiplexer connected to the weight generator for selecting one of the first parameter and a predetermined parameter;
a second multiplexer connected to the weight generator for selecting one of the second parameter and another predetermined parameter;
a first multiplier connected to the first multiplexer and the interpolation unit for calculating a product of the first reference pixel data multiplied by the first parameter;
a second multiplier connected to the second multiplexer and the linear process unit for calculating a product of the second reference pixel data multiplied by the second parameter ; and
an adder connected to the first multiplier and the second multiplier for generating the pixel data of the to-be-generated pixel according to a sum of the two products.

6. The multimedia device according to claim 5, wherein when the difference between the first pixel data and the second pixel data is larger than a threshold, the weight generator increases the first parameter and decreases the second parameter.

7. A motion compensation method of a multimedia device for generating a middle frame between a first frame and a second frame, which are received by the multimedia device, wherein the method comprises:
generating a first reference pixel data according to the ordering relationship among a first pixel data of the first frame, a second pixel data of the second frame, and a third pixel data, wherein the first pixel data and the second pixel data are obtained according to the location of a to-be-generated pixel of the middle frame and a relevant motion vector, and the third pixel data is obtained according to two pixel data which have substantially the same location in the first and the second frames as that of the to-be-generated pixel in the middle frame;
generating a second reference pixel data by linearly combining the first pixel data and the second pixel data; and
combining the first reference pixel data and the second reference pixel data according to a difference between the first pixel data and the second pixel data to generate a pixel data for the to-be-generated pixel.

8. The motion compensation method according to claim 7, wherein in the step of generating the first reference pixel data, the first reference pixel data is generated according to a median among the first pixel data, the second pixel data, and the third pixel data.

9. The motion compensation method according to claim 7, wherein in the step of generating the second reference pixel data, the second reference pixel data is generated according to a mean between the first pixel data and the second pixel data.

10. The motion compensation method according to claim 7, wherein in the step of generating the pixel data of the to-be-generated pixel, the first reference pixel data and the second reference pixel data are linearly combined with each other according to the difference between the first pixel data and the second pixel data to generate the pixel data for the to-be-generated pixel.

11. The motion compensation method according to claim 10, wherein the step of linearly combining the first reference pixel data and the second reference pixel data according to the difference further comprises:
determining a first parameter and a second parameter according to the difference between the first pixel data and the second pixel data;
calculating a product of the first reference pixel data multiplied by the first parameter and a product of the second reference pixel data multiplied by the second parameter; and
generating the pixel data of the to-be-generated pixel according to a sum of the two products.

12. The motion compensation method according to claim 11, wherein the step of linearly combining the first reference pixel data and the second reference pixel data according to the difference further comprises:
determining whether the difference between the first pixel data and the second pixel data is larger than a threshold, if the determination result is affirmative, then the first parameter is increased and the second parameter is decreased.
